(19) United States
(12) Patent Application Publication
(10) Pub. No.: US 2017/0170543 A1
(43) Pub. Date: Jun. 15, 2017

(54) ANTENNA AND ELECTRIC DEVICE USING THE SAME

(71) Applicant: ASUSTeK COMPUTER INC., Taipei City (TW)

(72) Inventors: Cheng-Tse Lee, Taipei City (TW); Saou-Wen Su, Taipei City (TW)

(73) Assignee: ASUSTeK COMPUTER INC., Taipei City (TW)

(21) Appl. No.: 15/376,682

(22) Filed: Dec. 13, 2016

(30) Foreign Application Priority Data
Dec. 15, 2015 (TW) 104142046

(51) Int. Cl. H01Q 1/22; H01Q 9/04; H01Q 1/48

(52) U.S. Cl. CPC H01Q 1/2266; H01Q 1/48; H01Q 9/0421

(57) ABSTRACT

An antenna is provided. The antenna includes: an antenna ground plane; a radiating unit parallel to the antenna ground plane, the radiating unit including: a common unit; a first branch extended from the common unit along a first direction; a second branch extended from the common unit along a second direction, wherein the first direction and the second direction are inverse; a third branch separated from the first branch and the second branch and extending outwardly from the common unit; a shorting unit located between a plane of radiating unit located and a plane of the antenna ground plane and connected to the common unit and the antenna ground plane; and a feeding unit located between a plane of the radiating unit and a plane of the antenna ground plane, wherein the feeding unit is separated from the shorting unit and connected to the third branch, and the shorting unit and the feeding unit are located on the same side.

### CROSS-REFERENCE TO RELATED APPLICATION

This application claims the priority benefit of TW application serial No. 104142046, filed on Dec. 15, 2015. The entirety of the above-mentioned patent application is hereby incorporated by reference herein and made a part of specification.

### BACKGROUND OF THE INVENTION

Field of the Invention

The present invention relates to an electronic unit and an electronic device, and more particularly, relates to an antenna and electronic device using the same.

Description of the Related Art

Antennas for wireless communication devices are usually disposed in clearance areas around the panel of the wireless communication devices, and a metal plate behind the panel is used as an antenna ground plane. Also, owing to the plastic back cover of the wireless communication devices, the antennas usually have good radiation performance. Recently, the devices having attractive appearance with the overall metallic back cover or housing have become trendy. However, the radiation performance of the antennas is easily affected, which resulting in signal interruption. Besides, the height of the antennas should also be reduced to conform to the slim wireless communication devices. The conventional antenna designs no longer satisfy the requirements of the products.

### BRIEF SUMMARY OF THE INVENTION

According to first aspect of the disclosure, an antenna includes: an antenna ground plane; a radiating unit parallel to the antenna ground plane, the radiating unit including: a common unit; a first branch extended from the common unit along a first direction; a second branch extended from the common unit along a second direction, wherein the first direction and the second direction are inverse; a third branch separated from the first branch and the second branch and extending outwardly from the common unit; a shorting unit located between a plane of radiating unit located and a plane of the antenna ground plane and connected to the common unit and the antenna ground plane; and a feeding unit located between a plane of the radiating unit and a plane of the antenna ground plane, wherein the feeding unit is separated from the shorting unit and connected to the third branch, and the shorting unit and the feeding unit are located on the same side.

According to second aspect of the disclosure, an electronic device, includes: a housing, and an antenna, including: an antenna ground plane; a radiating unit parallel to the antenna ground plane, the radiating unit which includes: a common unit; a first branch extended from the common unit along a first direction; a second branch extended from the common unit along a second direction, wherein the first direction and the second direction are inverse; a third branch separated from the first branch and the second branch and extending outwardly from the common unit; a shorting unit located between a plane of radiating unit located and a plane of the antenna ground plane and connected to the common unit and the antenna ground plane; and a feeding unit located between a plane of the radiating unit and a plane of the antenna ground plane, wherein the feeding unit is separated from the shorting unit and connected to the third branch, the shorting unit and the feeding unit are located on the same side, and the antenna ground plane is located between the feeding unit and the housing.

### BRIEF DESCRIPTION OF THE DRAWINGS

These and other features, aspects and advantages of the invention will become better understood with regard to the following embodiments and accompanying drawings.

FIG. 1 is a perspective view of an antenna in an embodiment.

FIG. 2 is a schematic diagram of the antenna in FIG. 1 after unfolded.

FIG. 3 is curve showing a return loss of an antenna in an embodiment.

FIG. 4 is a field pattern of an antenna operated in the 2442 MHz center frequency of the 2.4 GHz frequency band in an embodiment.

FIG. 5 is a schematic view of an electronic device in an embodiment.

FIG. 6 is a schematic diagram showing a portion of the housing, the antenna and the display unit of the electronic device of FIG. 5.

### DETAILED DESCRIPTION OF THE EMBODIMENTS

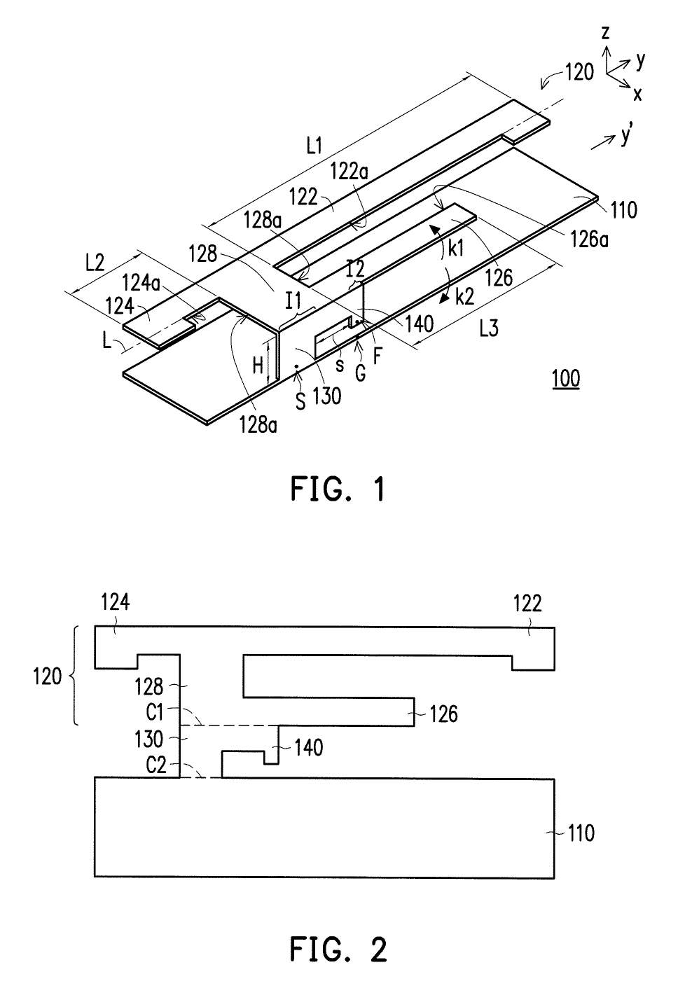

FIG. 1 is a perspective view of an antenna in an embodiment of the present invention. Referring to FIG. 1, an antenna 100 includes an antenna ground plane 110, a radiating unit 120, a shorting unit 130 and a feeding unit 140. The antenna ground plane 110 has a ground point G. In an embodiment, the antenna ground plane 110 is approximate to a quadrangle conductive plane, such as a rectangular conductive plate. The shape is not limited herein.

The radiating unit 120 is parallel to the antenna ground plane 110. The radiating unit 120 includes a first branch 122, a second branch 124, a third branch 126 and a common unit 128. In an embodiment, the first branch 122, the second branch 124, the third branch 126 and the common unit 128 are located on the same plane. The plane at which the first branch 122, the second branch 124, the third branch 126 and the common unit 128 are located (such as a x-y plane) is parallel to the plane of the antenna ground plane 110 (such as a plane under the x-y plane), which is not limited herein.

The first branch 122 extends from the common unit 128 along the y axis direction. The second branch 124 extends from the common unit along the −y axis direction. The y axis direction and the −y axis direction are inverse. In other words, the first branch 122 and the second branch 124 are located in different sides of the common unit 128 and extend in opposite directions y and -y, respectively. Further, in an embodiment, the first branch 122 and the second branch 124 are located at the same straight line, which is not limited herein. The first branch 122 and the second branch 124 are approximately long strips. The first branch 122 has a long side 122a perpendicular to the edge 128a of the common unit 128. The second branch 124 has a long side 124a perpendicular to the edge 128a of the common unit 128.

The third branch 126 is separated from the first branch 122 and the second branch 124 and extends outwardly from the common unit 128. For example, in an embodiment, the third branch 126 extends from the common unit 128 along the y′ direction which is parallel to the y direction. In other words, the first branch 122 and the third branch 126 are located in the same side of the common unit 128 and extend along the parallel direction y, y′, respectively. In an embodiment, the third branch 126 and the second branch 124 are not overlapped in the y direction. The third branch 126 is approximately a long strip. In an embodiment, a long side 126a of the third branch 126 is perpendicular to the edge 128a of the common unit 128.

The length of the first branch 122 is L1. The length of the second branch is L2. The length of the third branch 126 is L3. In an embodiment, the L1, L2 and L3 are different from each other to allow the antenna 100 to operate at multiple frequency bands. For example, in an embodiment, the L1 is greater than the L3, and the L3 is greater than the L2, which is not limited herein.

The shorting unit 130 is located between the plane of the radiating unit 120 and the plane of the antenna ground plane 110. The shorting unit 130 has a short point S. The shorting unit 130 is connected to the common unit 128 of the radiating unit 120 and the antenna ground plane 110. In an embodiment, the plane of the shorting unit 130 (for example, the plane is parallel to the y-z plane) is perpendicular to the antenna ground plane 110, which is not limited herein. Two opposite sides of the shorting unit 130 are directly connected to the common unit 128 of the radiating unit 120 and the antenna ground plane 110, respectively. The shorting unit 130 is electronically connected to the common unit 128 and the antenna ground plane 110.

The feeding unit 140 is located between the plane of the radiating unit 120 and the plane of the antenna ground plane 110. The feeding unit 140 has a feed point F. The feed point F is located above the ground point G. The feeding unit 140 is separated from the shorting unit 130. The feeding unit 140 is directly connected to the third branch 126 of the radiating unit 120 and doesn't contact with the antenna ground plane 110. In an embodiment, the feeding unit 140 and the shorting unit 130 are located on the same plane. The plane of the feeding unit 140 and the shorting unit 130 is perpendicular to the plane of the antenna ground plane 110, which is not limited herein.

The shorting unit 130 and the feeding unit 140 are located on the same side. In other words, if the common unit 128 and the third branch 126 are regarded as a piece (such as L type conductive piece), the shorting unit 130 and the feeding unit 140 are located at the same side of the piece and connected to the piece. In a word, the shorting unit 130 and the feeding unit 140 are located on the same side of the antenna 100. The high capacitive reactance value generated due to the reduction of the height H of the antenna 100 (the height H is the height between the antenna ground plane 110 and the radiating unit 120) can be compensated by adjusting the distance s (or the inductive reactance) between the shorting unit 130 and the feeding unit 140 which are at the same side. Consequently, good performance of the antenna 100 is obtained while the height H of the antenna 100 (such as less than 4 millimeter) is reduced. FIG. 2 is a schematic diagram of the antenna in FIG. 1 after unfolded. The antenna 100 of FIG. 1 can be formed by bending the conductive piece of FIG. 2. In other words, in the embodiment, the antenna ground plane 110, the radiating unit 120, the shorting unit 130 and the feeding unit 140 are integrally formed. Referring to FIG. 1 and FIG. 2, when the shorting unit 130 and the feeding unit 140 are parallel to the same plane, the radiating unit 120 is bent by 90 degrees along the bending line C1 toward the k1 direction, and the antenna ground plane 110 is bent by 90 degrees along the bending line C2 toward the k2 direction, the conductive piece in FIG. 2 is bent to form the antenna 100 in FIG. 1.

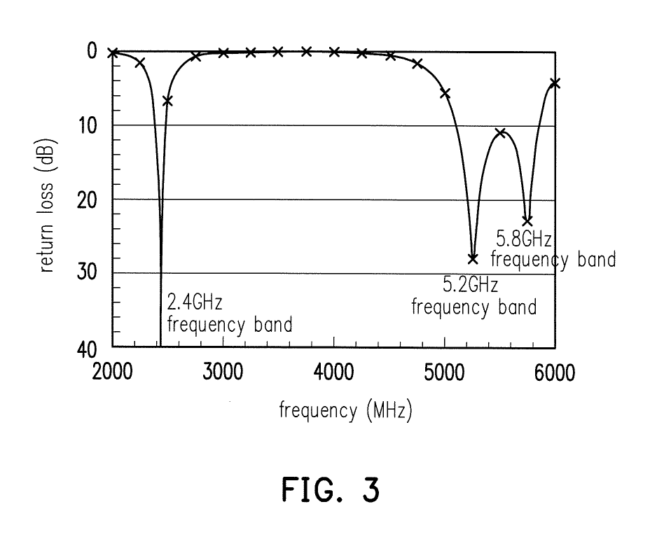

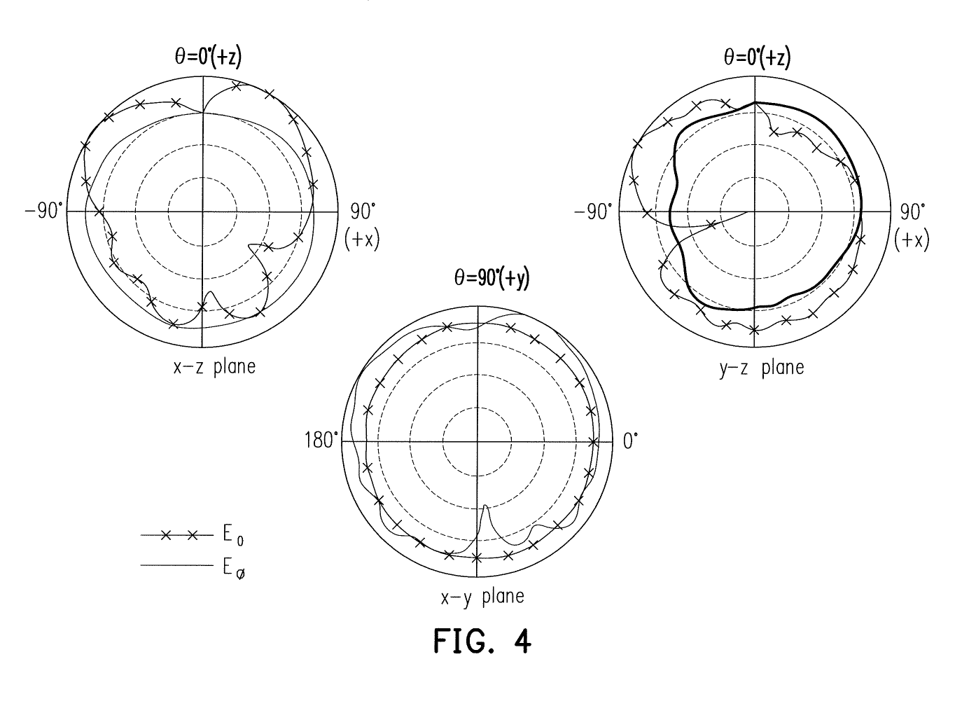

FIG. 3 is a curve of showing a return loss of then antenna 100 according to an embodiment. Referring to FIG. 3, the antenna 100 of FIG. 1 can operate at the operating frequency band near 2.4 GHz (such as the operation frequency between 2400˜2484 MHz) and 5 GHz operating band (such as the operation frequency between 5150˜5825 MHz). Moreover, the impedance bandwidth of the antenna 100 can meet the requirement of the return loss of a specific decibel (dB). FIG. 4 is a radiation pattern of an antenna operated at 2442 MHz center frequency of 2.4 GHz frequency band in an embodiment. In FIG. 4, the stronger of the curve E₀ and the curve E_{φ} is a main polarization curve, the weaker one is a cross polarization curve. As seen the radiation pattern of the x-z plane, the y-z plane and the x-y plane in FIG. 4, when the antenna 100 is operated at 2442 MHz center frequency, the antenna 100 is a quasi-omnidirectional antenna. As shown in FIG. 4, the antenna 100 with slim height still has a good performance.

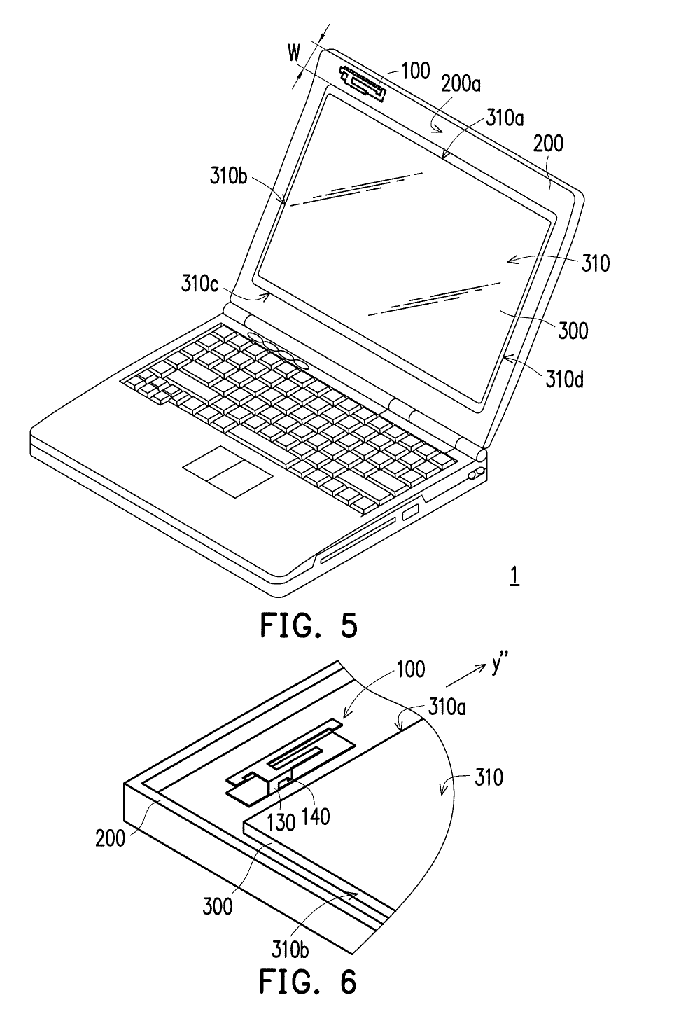

FIG. 5 is a schematic view of an electronic device in an embodiment of the present invention. Referring to FIG. 5, the electronic device 1 includes a housing 200 and an antenna 100 installed in the housing 200. The antenna ground plane 110 is located between the radiating unit 120 and the housing 200. In an embodiment, the electronic device is a notebook or a tablet computer, and the housing is a cover of a notebook or a tablet computer, which is not limited herein. In an embodiment, the electronic device is a smartphone, or a smart television including the housing 200 and the antenna 100. In an embodiment, the housing 200 of the electronic device 1 is a metal, and the antenna ground plane 100 is electronically connected to the metal housing 200, which is not limited herein.

Referring to FIG. 5, the electronic device 1 of the embodiment further includes a display unit 300 installed in the housing 200. FIG. 6 is a schematic diagram showing a portion of the housing 200, the antenna 100 and the display unit 300 of the electronic device 1 of FIG. 5. For the charity, the top surface 200a parallel to the rectangle display surface 310 of the housing 200 is not shown in FIG. 5. Referring to FIG. 5 and FIG. 6, the display unit 300 includes a rectangle display surface 310. The rectangle display surface 310 has four edges 310a, 310b, 310c and 310d. The antenna 100 is next to the edge 310a of the rectangle display surface 310 among the edge 310a, 310b, 310c and 310d. The arrangement direction y″ of the shorting unit 130 and the feeding unit 140 are parallel to the edge 310a. Consequently, when the distance s between the shorting unit 130 and the feeding unit 140 is adjusted to compensate for the high capacitive reactance value between the antenna ground plane 110 and the radiating unit 120, the increase distance s would not affect the width W of the board of the electronic device 1. In other words, the electronic device 1 using the antenna 100 can be in a thin type, while the antenna 100 has good performance of receiving and transmitting signals.

In conclusion, in an antenna according to an embodiment, the first branch of the radiating unit extends from the common unit along a first direction, the second branch of the radiating unit extends from the common unit along a second direction, the first direction and the second direction are inverse. The shorting unit and the feeding unit are located on the same side. Since the shorting unit and the feeding unit are located on the same side of the whole antenna, the high capacitive reactance value generated due to the low height between the antenna ground plane and the radiating unit is easily compensated by adjusting the distance between the short unit and the feeding unit. As a result, the antenna has a good performance even when height of the antenna is reduced, which is more elastic in design.

Although the invention has been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. An antenna including:
an antenna ground plane;
a radiating unit parallel to the antenna ground plane, the radiating unit including:
a common unit;
a first branch extended from the common unit along a first direction;
a second branch extended from the common unit along a second direction, wherein the first direction and the second direction are inverse;
a third branch separated from the first branch and the second branch and extending outwardly from the common unit;
a shorting unit located between a plane of radiating unit located and a plane of the antenna ground plane and connected to the common unit and the antenna ground plane; and
a feeding unit located between a plane of the radiating unit and a plane of the antenna ground plane, wherein the feeding unit is separated from the shorting unit and connected to the third branch, and the shorting unit and the feeding unit are located on the same side.

2. The antenna according to claim 1, wherein the second branch and the third branch are not overlapped in the second direction.

3. The antenna according to claim 1, wherein the third branch extends from the common unit to a third direction, and the third direction is parallel to the first direction.

4. The antenna according to claim 1, wherein the length of the first branch, the second branch and the third branch are different from each other.

5. The antenna according to claim 1, wherein the antenna ground plane, the radiating unit, the shorting unit and the feeding unit are integrally formed.

6. The antenna according to claim 1, wherein the first branch and the second branch are located at a same straight line.

7. An electronic device, including:
a housing, and
an antenna, including:
an antenna ground plane;
a radiating unit parallel to the antenna ground plane, the radiating unit including:
a common unit;
a first branch extended from the common unit along a first direction;
a second branch extended from the common unit along a second direction, wherein the first direction and the second direction are inverse;
a third branch separated from the first branch and the second branch and extending outwardly from the common unit;
a shorting unit located between a plane of radiating unit located and a plane of the antenna ground plane and connected to the common unit and the antenna ground plane; and
a feeding unit located between a plane of the radiating unit and a plane of the antenna ground plane, wherein the feeding unit is separated from the shorting unit and connected to the third branch, the shorting unit and the feeding unit are located on the same side, and the antenna ground plane is located between the feeding unit and the housing.

8. The electronic device according to claim 7, wherein the housing is a metallic housing.

9. The electronic device according to claim 7, further including a display installed in the housing.

10. The electronic device according to claim 9, wherein the display includes a rectangle display surface, the rectangle display surface includes four edges, the antenna is configured next to one of the edges, and the arrangement direction of the feeding unit and the shorting unit is parallel to the one of the edges.

11. The electronic device according to claim 7, wherein the second branch and the third branch are not overlapped in the second direction.

12. The electronic device according to claim 7, wherein the third branch extends from the common unit towards a third direction, and the third direction is parallel to the first direction.

13. The electronic device according to claim 7, wherein the first branch includes a first length, the second branch includes a second length, the third branch includes a third length, the first length, the second length and the third length are different from each other.

14. The electronic device according to claim 7, wherein the antenna ground plane, the radiating unit, the shorting unit and the feeding unit are integrally formed.

15. The electronic device according to claim 7, wherein the first branch and the second branch are located at a same straight line.
